(19) United States
(12) Patent Application Publication
(10) Pub. No.: US 2010/0310805 A1
(43) Pub. Date: Dec. 9, 2010

(54) ARTICLES CONTAINING SILICONE COMPOSITIONS AND METHODS OF MAKING SUCH ARTICLES

(75) Inventors: Duan Li Ou, Northboro, MA (US); Scott R. Johnson, Troy, NY (US); Mark W. Simon, Pascoag, RI (US)

Correspondence Address: LARSON NEWMAN & ABEL, LLP, 5914 WEST COURTYARD DRIVE, SUITE 200, AUSTIN, TX, 78730, US

(73) Assignee: SAINT-GOBAIN PERFORMANCE PLASTICS CORPORATION, Aurora, OH (US)

(21) Appl. No.: 12/796,394

(22) Filed: Jun. 8, 2010

Related U.S. Application Data
(60) Provisional application No. 61/184,927, filed on Jun. 8, 2009.

(51) Int. Cl. B32B 1/08; B32B 27/08; B32B 37/00

(52) U.S. Cl. 428/36.91; 428/421; 428/422; 156/60

(57) ABSTRACT

The disclosure is directed to an article includes a first layer and a second layer. The first layer includes a silicone base polymer and a hydride-containing siloxane, wherein the hydride-containing siloxane is present at about 0.1% by weight to about 5.0% by weight of the silicone base polymer and the second layer includes a fluoropolymer.

### CROSS-REFERENCE TO RELATED APPLICATION(S)

The present application claims priority from U.S. Provisional Patent Application No. 61/184,927, filed Jun. 8, 2009, entitled “Articles Containing Silicone Compositions and Methods of Making Such Articles,” naming inventor Duan Li Ou, Scott R. Johnson, and Mark W. Simon, which application is incorporated by reference herein in its entirety.

### FIELD OF THE DISCLOSURE

This disclosure, in general, relates to an article having selective adhesion and a method for making the article.

### BACKGROUND

Curable silicone compositions are used in a variety of applications that range from the automotive industry to medical devices. In many cases, the silicone composition is coupled to a variety of substrates such as polymeric, metallic, or glass substrates. For instance, silicone compositions are used as a coating or a laminate over a variety of polymeric substrates.

Typically, a primer is used between the silicone composition and the substrate. The use of a primer increases the volatile organic contaminant (VOC) content of the resulting silicone containing parts. Further, the use of a primer increases the number of steps in the manufacturing process. For instance, primer is firstly applied to the surface of a substrate and needs a pre-bake and a post-bake to facilitate adhesion between the silicone composition and the substrate and decrease the VOC content of the material. The resulting silicone/substrate combination containing the primer may increase the adhesion of the silicone composition to the substrate; however, the resulting material may barely pass industrial VOC specifications due to the VOC contents in the primer.

Without a primer, the volatile organic contaminant level is typically decreased. Unfortunately, the silicone formulation may have problems bonding to the substrate during the manufacturing process and the resulting product is not suitable for its designated usage. Commercially available self-bonding silicone rubbers can be used to bond to the silicone rubber to a wide range of substrate materials. In particular, the typical self-bonding silicone formulation can bond to both a polymer substrate and the laminator, which is typically a metal roller. To minimize the adhesion of the silicone formulation to the metal roller, the metal roll laminator typically needs to be constantly maintained and treated with a coating to prevent the silicone formulation from sticking to the manufacturing equipment. As a result, manufacturers are often left to choose between a silicone material with primer or a self-bonding silicone material, i.e., a higher volatile organic contaminant level or constant maintenance of the manufacturing equipment.

As such, an improved silicone formulation and method of manufacturing silicone-including articles would be desirable.

### SUMMARY

In a particular embodiment, an article includes a first layer and a second layer. The first layer includes a silicone base polymer and a hydride-containing siloxane, wherein the hydride-containing siloxane is present at about 0.1% by weight to about 5.0% by weight of the silicone base polymer. The second layer includes a fluoropolymer. The first layer has a peel strength of at least about 10.0 ppi to the second layer and a peel strength of not greater than about 7.0 ppi to a metal.

In another exemplary embodiment, an article includes a first layer and a second layer. The first layer includes a silicone base polymer and a hydride-containing siloxane, wherein the hydride-containing siloxane is present at about 0.1% by weight to about 5.0% by weight of the silicone base polymer. The second layer includes a fluoropolymer. The article has a volatile organic contaminant (VOC) level that is substantially undetectable for 4-methyl-2-pentanone as measured by gas chromatography-mass spectrometry (GC MS).

In an embodiment, a tube includes a liner including a fluoropolymer. A tie layer overlies the liner. The tie layer includes a silicone material including a silicone base polymer and a hydride-containing siloxane, wherein the hydride-containing siloxane is present at about 0.1% by weight to about 5.0% by weight of the silicone base polymer. A reinforced layer overlies the tie layer. The reinforced layer includes a silicone material including a silicone base polymer and a hydride-containing siloxane, wherein the hydride-containing siloxane is present at about 0.1% by weight to about 5.0% by weight of the silicone base polymer and at least one polyester reinforcement member substantially embedded within the silicone material. A cover layer overlies the reinforced layer. The cover layer includes a silicone material including a silicone base polymer and a hydride-containing siloxane, wherein the hydride-containing siloxane is present at about 0.1% by weight to about 5.0% by weight of the silicone base polymer.

In a further exemplary embodiment, a method of making an article includes providing a first layer and providing a second layer to form an article. The first layer includes a silicone base polymer and a hydride-containing siloxane, wherein the hydride-containing siloxane is present at about 0.4% by weight to about 2.0% by weight of the silicone base polymer. The second layer is disposed directly on the first layer and includes a fluoropolymer.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary selected adhesion mechanism.

FIG. 2 includes an illustration of an exemplary multilayer article.

FIG. 3 includes an illustration of an exemplary multilayer tube.

### DESCRIPTION OF THE DRAWINGS

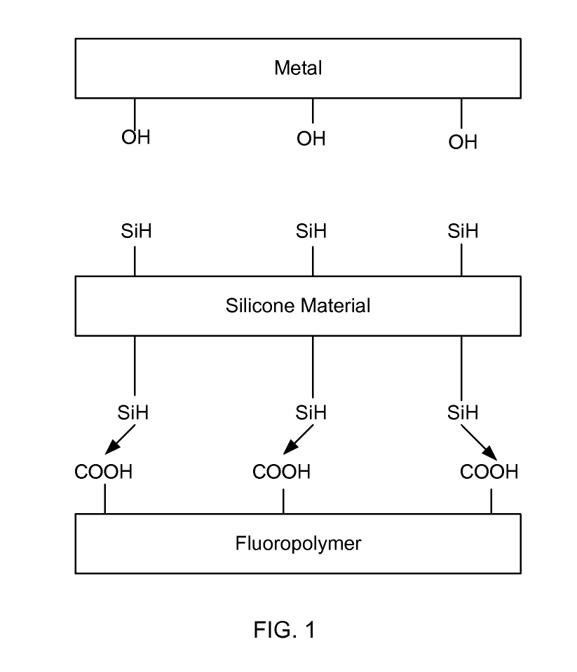

In a particular embodiment, a silicone material includes a silicone base polymer and a hydride-containing siloxane. Generally, the hydride-containing siloxane is present in excess to any hydride-containing siloxane provided with the silicone base polymer. The incorporation of the hydride-containing siloxane into the silicone base polymer provides a silicone material that has selective adhesion. “Selective adhesion” as used herein refers to a silicone material that substantially adheres to a fluoropolymer and does not substantially adhere to metal. Exemplary metals may include stainless steel, steel, titanium, aluminum, or any combination thereof. As seen in FIG. 1, excess hydride-containing silicone may react to carboxyl groups (COOH) that are on the surface of the fluoropolymer but do not react to hydroxyl groups (OH) on the metal. In particular, selective adhesion of the silicone material is achieved without a primer.

The hydride-containing siloxane is present in excess to any hydride-containing siloxane provided in the silicone base polymer. In particular, the hydride-containing siloxane is present in an effective amount to provide a silicone material that substantially adheres to a fluoropolymer and does not substantially adhere to metals. In an embodiment, an “effective amount” is excess hydride-containing siloxane of about 0.1 weight % to about 5.0 weight %, such as about 0.4 wt % to about 2.0 wt %, or about 1.0 wt % to about 2.0 wt % of the total weight of the silicone base polymer. Exemplary hydride-containing siloxanes include hydride-containing polydialkylsiloxane, polyalkylhydrosiloxane, and the like. Particular embodiments of a hydride-containing polydialkylsiloxane include, for example, HMS031, HMS271, HMS991, HMS993, HMS082, which are available from Gelest. Cross Linker 100, Cross linker 101, Cross Linker 110, Cross Linker 210, available from Hanse Chemie.

In an exemplary embodiment, the silicone base polymer may include a non-polar silicone polymer. The silicone base polymer may, for example, include polyalkylsiloxanes, such as silicone polymers formed of a precursor, such as dimethylsiloxane, diethylsiloxane, dipropylsiloxane, methylethylsiloxane, methylpropylsiloxane, or combinations thereof. In a particular embodiment, the polyalkylsiloxane includes a polydialkylsiloxane, such as polydimethylsiloxane (PDMS). In a particular embodiment, the polyalkylsiloxane is a silicone hydride-containing polydimethylsiloxane. In a further embodiment, the polyalkylsiloxane is a vinyl-containing polydimethylsiloxane. In yet another embodiment, the silicone base polymer is a combination of a hydride-containing polydimethylsiloxane and a vinyl-containing polydimethylsiloxane. In an example, the silicone base polymer is non-polar and is free of halide functional groups, such as chlorine and fluorine, and of phenyl functional groups. Alternatively, the silicone base polymer may include halide functional groups or phenyl functional groups. For example, the silicone base polymer may include fluorosilicone or phenylsilicone. Typically, the silicone base polymer is elastomeric. For example, the durometer (Shore A) of the silicone base polymer may be less than about 75, such as about 1 to 70, about 20 to about 50, about 30 to about 50, about 40 to about 50, or about 1 to about 5.

The silicone base polymer may further include a catalyst and other optional additives. Exemplary additives may include, individually or in combination, fillers, inhibitors, colorants, and pigments. In an embodiment, the silicone base polymer is platinum catalyzed. Alternatively, the silicone base polymer may be peroxide catalyzed. In another example, the silicone base polymer may be a combination of platinum catalyzed and peroxide catalyzed. The silicone base polymer may be a room temperature vulcanizable (RTV) formulation or a gel. In an example, the silicone base polymer may be a high consistency gum rubber (HCR) or a liquid silicone rubber (LSR). In an example, the silicone base polymer is an HCR, such as SE6035, SE6075 available from Momentive, MF135 available from Bluestar silicone, and Silastic® Q7-4535, Silastic® Q7-4550 available from Dow Corning.

In a particular embodiment, the silicone base polymer is a platinum catalyzed LSR. In a further embodiment, the silicone base polymer is an LSR formed from a two-part reactive system. The silicone base polymer may be a conventional, commercially prepared silicone base polymer. The commercially prepared silicone base polymer typically includes the non-polar silicone polymer, a catalyst, a filler, and optional additives. Particular embodiments of conventional, commercially prepared LSR include Wacker Elastosil® LR 3003/50 by Wacker Silicone of Adrian, Mich. and Silbione® LSR 4340 by Bluestar Silicones of Ventura, Calif.

In an exemplary embodiment, a commercially prepared silicone base polymer is available as a one-part or two-part reactive system. With a two-part reactive system, part 1 typically includes a vinyl-containing polydialkylsiloxane, a filler, and catalyst. Part 2 typically includes a hydride-containing polydialkylsiloxane and optionally, a vinyl-containing polydialkylsiloxane and other additives. A reaction inhibitor may be included in Part 1 or Part 2. Mixing Part 1 and Part 2 by any suitable mixing method produces the silicone base polymer. With a one-part system or two-part system, the excess hydride-containing siloxane is typically added to the commercially prepared silicone base polymer prior to vulcanization. In an embodiment, the excess hydride-containing siloxane is added to the mixed two-part system or during the process of mixing the two-part system prior to vulcanization. In an exemplary embodiment, the silicone base polymer and the excess hydride-containing siloxane are mixed in a mixing device. In an example, the mixing device is a mixer in an injection molder. In another example, the mixing device is a mixer, such as a dough mixer, Ross mixer, two-roll mill, or Brabender mixer.

The silicone material containing the excess hydride-containing siloxane exhibits improved adhesion to fluoropolymers. An exemplary fluoropolymer may be formed of a homopolymer, copolymer, terpolymer, or polymer blend formed from a monomer, such as tetrafluoroethylene, hexafluoropropylene, chlorotrifluoroethylene, trifluoroethylene, vinylidene fluoride, vinyl fluoride, perfluoropropyl vinyl ether, perfluoromethyl vinyl ether, or any combination thereof. For example, the fluoropolymer is polytetrafluoroethylene (PTFE). In an embodiment, the polytetrafluoroethylene (PTFE) may be processed. Processing may include paste extruding, skiving, expanded, biaxially stretched, or an oriented polymeric film.

Further exemplary fluoropolymers include a fluorinated ethylene propylene copolymer (FEP), a copolymer of tetrafluoroethylene and perfluoropropyl vinyl ether (PFA), a copolymer of tetrafluoroethylene and perfluoromethyl vinyl ether (MFA), a copolymer of ethylene and tetrafluoroethylene (ETFE), a copolymer of ethylene and chlorotrifluoroethylene (ECTFE), polychlorotrifluoroethylene (PCTFE), poly vinylidene fluoride (PVDF), a terpolymer including tetrafluoroethylene, hexafluoropropylene, and vinylidenefluoride (THV), or any blend or any alloy thereof. For example, the fluoropolymer may include FEP. In a further example, the fluoropolymer may include PVDF. In an exemplary embodiment, the fluoropolymer may be a polymer crosslinkable through radiation, such as e-beam. An exemplary crosslinkable fluoropolymer may include ETFE, THV, PVDF, or any combination thereof. A THV resin is available from Dyneon 3M Corporation Minneapolis, Minn. An ECTFE polymer is available from Ausimont Corporation (Italy) under the trade name Halar. Other fluoropolymers used herein may be obtained from Daikin (Japan) and DuPont (USA). In particular, FEP fluoropolymers are commercially available from Daikin, such as NP-12X.

In general, the silicone material including the excess hydride-containing siloxane exhibits desirable adhesion to the fluoropolymer without further treatment of the fluoropolymer surface. Alternatively, the fluoropolymer may be treated to further enhance adhesion. In an embodiment, the adhesion between the fluoropolymer and the silicone material may be improved through the use of a variety of surface treatments of the fluoropolymer. An exemplary surface treatment may include chemical etch, physical-mechanical etch, plasma etch, ion beam treatment, corona treatment, chemical vapor deposition, or any combination thereof. In an embodiment, the chemical etch includes sodium ammonia and sodium naphthalene. In an embodiment, the chemical treatment includes Ludox silica particles, which is commercially referred to as the Chemlink process. An exemplary physical-mechanical etch may include sandblasting and air abrasion. In another embodiment, plasma etching includes reactive plasmas such as hydrogen, oxygen, acetylene, methane, and mixtures thereof with nitrogen, argon, and helium. Corona treatment may include the reactive hydrocarbon vapors such as acetone. In an embodiment, the chemical vapor deposition includes the use of acrylates, vinylidene chloride, and acetone.

Applications for the silicone material and fluoropolymer are numerous. For instance, the silicone material and fluoropolymer may be used to produce multilayer articles such as, for example, laminates, coated fabrics, barrier and chemical resistant films, analytical septa, bearings, medical devices, and tubing and hosing. Tubing includes, for example, peristaltic pump tubing. In a particular embodiment, the silicone material and fluoropolymer may be used as analytical septa that are used in caps. Caps may include any suitable cap closures, for example, crimp seal closure caps, snap cap closures, and screw cap closures. Caps may also include open top cap closures as well as closed top cap closures. Any reasonable method to place the septa in the cap may be envisioned.

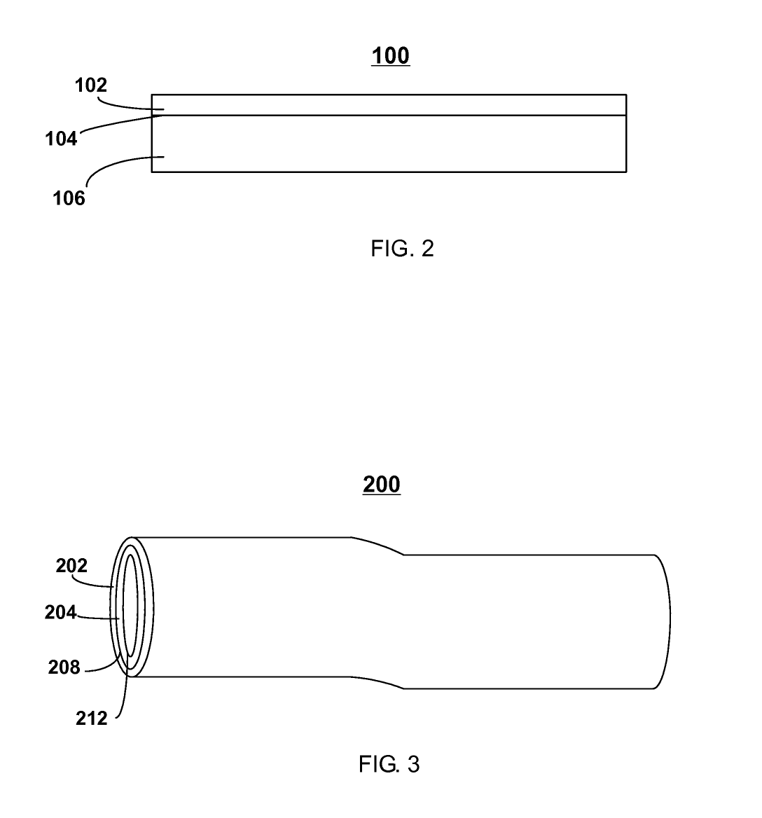

An exemplary embodiment of an article 100 is illustrated in FIG. 2. The article 100 includes fluoropolymer layer 102 having a major surface 104. The silicone material layer 106 overlies the major surface 104 of the fluoropolymer layer 102. In an embodiment, the major surface 104 of the fluoropolymer layer 102 is surface treated. In a particular embodiment, the fluoropolymer layer 102 directly contacts and is directly disposed on the silicone material layer 106. Typically, there are no intervening layers between the fluoropolymer layer 102 and the silicone material layer 106.

In an embodiment, the article may be formed through a method that includes providing a first layer, which includes the silicone material. In an embodiment, the silicone material includes a silicone base polymer of high consistency rubber (HCR) or liquid silicone rubber (LSR). The excess hydride-containing siloxane is mixed with the silicone base polymer. The silicone base polymer and hydride-containing siloxane may then be processed. For example, processing of the high consistency rubber with the hydride-containing siloxane may include any suitable method such as extrusion, jacketing, braiding, processing as a film, compression molding, and overmolding. In another example, processing of the liquid silicone rubber with the hydride-containing siloxane may include any suitable method such as compression molding, overmolding, liquid injection molding, co-processing of the LSR with a thermoplastic material, coating, or processing as a thin film.

The method further includes providing the second layer, which is the fluoropolymer layer, on the first layer. Typically, the fluoropolymer layer may be extruded, cast, or skived. In an embodiment, the fluoropolymer layer may be surface treated in order to create desirable surface properties. Any surface treatment occurs prior to providing the second layer on the first layer. In an embodiment, the first layer overlies and directly contacts the second layer to form the article. Particularly, the first layer overlies the second layer without any intervening layer or layers.

In a particular embodiment, the silicone/fluoropolymer article containing unprimed fluoropolymer does not require a pre-bake to achieve a desirable VOC level. Further, the silicone/fluoropolymer article containing unprimed fluoropolymer requires shorter post bake time to achieve desirable VOC level. In contrast, a silicone/fluoropolymer laminate that includes a primed fluoropolymer is typically pre-baked. For instance, a silicone material that includes a primer is pre-baked at a 200° C. for 4 hours prior to layering the primed fluoropolymer layer, on the silicone material. The silicone/fluoropolymer laminate that includes a primed fluoropolymer requires at least 10 hours post bake at 200° C. to reach desirable VOC; however, post bakes for this time and temperature can result in the degradation of the silicone material. The silicone material with the excess hydride-containing siloxane bonds to unprimed fluoropolymer is substantially free of primer. “Substantially free” as used herein refers to silicone material that does not include any conventional available primer. In particular, a conventional primer may not be present in the silicone material at greater than about 0.001% by weight of the total silicone material. Typically, a conventional primer may contain over 90% of VOC.

Once the article is formed, the article is subjected to thermal treatment for vulcanization. For instance, the conditions for thermal treatment provide selective adhesion of the silicone material to the fluoropolymer and the metal. Thermal treatment typically occurs at a temperature of about 125° C. to about 200° C. In an embodiment, the thermal treatment is at a temperature of about 150° C. to about 200° C. Typically, the thermal treatment occurs for a time period of about 1 minute to about 60 minutes, such as about 1 minute to about 30 minutes, or such as about 1 minute to about 10 minutes. In an embodiment, the thermal treatment is at a temperature of about 200° C. for a period of less than an about 30 minutes. In an embodiment, the thermal treatment is at a temperature of about 200° C. for a period of about 1 minute to about 10 minutes. In a particular embodiment, the thermal treatment is at a temperature of about 200° C. for a period of less than about 5 minutes.

In an embodiment, the article may be subjected to a post bake. For instance, the conditions for the post bake aids in the removal of any residual VOCs contained within the article. In an embodiment, post-bake may be at a temperature of about 180° C. to about 200° C. Typically, the post bake occurs for a time period of up to about 2 hours. In an embodiment, the post bake is at a temperature of about 200° C. for a period of about 2 hours.

In an embodiment, radiation crosslinking or radiative curing may be performed once the article is formed. The radiation may be effective to crosslink the silicone material. The intralayer crosslinking of polymer molecules within the silicone material provides a cured material and imparts structural strength to the silicone material of the article. In addition, radiation may effect a bond between the silicone material and the fluoropolymer, such as through interlayer crosslinking. In a particular embodiment, the combination of interlayer crosslinking bonds between the fluoropolymer and the silicone material present an integrated composite that is highly resistant to delamination, has a high quality of adhesion resistant and protective surface, incorporates a minimum amount of adhesion resistant material, and yet, is physically substantial for convenient handling and deployment of the article. In a particular embodiment, the radiation may be ultraviolet electromagnetic radiation having a wavelength between 170 nm and 400 nm, such as about 170 nm to about 220 nm. In an example, crosslinking may be effected using at least about 120 J/cm² radiation.

An exemplary article is a multi-layer tube 200. As illustrated in FIG. 3, the multi-layer tube 200 is an elongated annular structure with a hollow central bore. The multi-layer tube 200 includes a cover 201, a reinforced layer 202, a tie layer 203, and a liner 204. Typically, the cover 201 and the tie layer 203 are the silicone material. In an embodiment, the reinforced layer 202 includes the silicone material with a reinforcement member substantially embedded within the silicone material of the reinforced layer 202. “Substantially embedded” as used herein refers to a reinforcement member wherein at least 25%, such as at least about 50%, or even 100% of the total surface area of the reinforcement member is embedded in the silicone material. The reinforcement member can be any material that increases the reinforcing properties of the multi-layer article. For instance, the reinforcement member may include natural fibers, synthetic fibers, or combination thereof. In an embodiment, the fibers may be in the form of a knit, laid scrim, braid, woven, or non-woven fabric. Exemplary reinforcement fibers include glass, aramids, polyamides, polyesters, and the like. In an exemplary embodiment, the reinforcement member substantially embedded within the silicone material includes a polyester material. In an embodiment, the reinforced layer may have a thickness of less than about 5.0 mm, such as not greater than about 2.0 mm. In an embodiment, the silicone material for the cover 201, reinforced layer 202, and tie layer 203 may be the same or different. In a particular embodiment, the silicone material for the reinforced layer 202 and the tie layer 203 is the same. In an embodiment, the liner 204 is the fluoropolymer.

In an exemplary embodiment, the multi-layer tube includes two layers, such as the cover and the liner. In an embodiment, the cover may be directly in contact with and may directly bond to a liner along an outer surface of the liner. For example, the cover may directly bond to the liner without intervening adhesive layers. In an embodiment, a third layer may be included as part of the multi-layer tube. Any appropriate layer may be envisioned such as a reinforcement layer, polymeric layers, an adhesive layer, and the like.

The multi-layer tube may be formed through a method wherein the silicone material cover is extruded or wrapped over the fluoropolymer liner. The liner includes an inner surface that defines a central lumen of the tube. Prior to extrusion of the cover, adhesion between the liner and the cover may be improved through the use of a surface treatment of the outer surface of the liner. A surface treatment may include chemical etch, physical-mechanical etch, plasma etch, corona treatment, chemical vapor deposition, or any combinations thereof. In an embodiment, the chemical etch includes sodium ammonia and sodium naphthalene. Physical-mechanical etch may include sandblasting and air abrasion. In another embodiment, plasma etching includes reactive plasmas such as hydrogen, oxygen, acetylene, methane, and mixtures thereof with nitrogen, argon, and helium. Corona treatment may include the reactive hydrocarbon vapors, such as acetone. In an embodiment, the chemical vapor deposition includes the use of acrylates, vinylidene chloride, or acetone.

In an exemplary embodiment, the multi-layer tube 200 may be formed through a method wherein the layers containing the silicone material 201, 202, 203 are built over the fluoropolymer liner 204. In an embodiment, the layers containing the silicone material 201, 202, 203 are extruded together, extruded separately, or wrapped separately. The liner 204 includes an inner surface 205 that defines a central lumen of the tube 200. Prior to the build up of silicone containing layers, adhesion between the liner 204 and the tie layer 203 may be improved through the use of a surface treatment of the outer surface 206 of the liner 204. A surface treatment may include chemical etch, physical-mechanical etch, plasma etch, corona treatment, chemical vapor deposition, or any combinations thereof. In an embodiment, the chemical etch includes sodium ammonia and sodium naphthalene. Physical-mechanical etch may include sandblasting and air abrasion. In another embodiment, plasma etching includes reactive plasmas such as hydrogen, oxygen, acetylene, methane, and mixtures thereof with nitrogen, argon, and helium. Corona treatment may include the reactive hydrocarbon vapors, such as acetone. In an embodiment, the chemical vapor deposition includes the use of acrylates, vinylidene chloride, or acetone.

Once the multi-layer tube is formed, the multi-layer tube may be subjected to a thermal treatment, post bake, radiation crosslinking, radiative curing, or combination thereof.

In general, the cover 201 has greater thickness than the liner 204. The total tube thickness of the multi-layer tube 200 may be at least about 3 mils to about 50 mils, such as about 3 mils to about 20 mils, or about 3 mils to about 10 mils. In an embodiment, the liner 204 has a thickness of about 1 mil to about 20 mils, such as about 3 mils to about 10 mils, or about 1 mil to about 2 mils.

In an exemplary embodiment, the silicone material advantageously exhibits selective peel strength. In an embodiment, the silicone material substantially adheres to a fluoropolymer and does not substantially adhere to a metal. In an embodiment, “substantially adheres” refers to a silicone material that has desirable peel strength when applied to a fluoropolymer. In particular, the peel strength may be significantly high or the article may even exhibit cohesive failure during testing. “Cohesive failure” as used herein indicates that the silicone material or the article ruptures before the bond between the silicone material and the fluoropolymer fails. In an embodiment, the silicone material and fluoropolymer has a peel strength of at least about 10.0 pounds per inch (ppi), such as at least about 15.0 ppi, such as at least about 20.0 ppi, or even enough to lead to cohesive failure, when tested in with a standard 180° peel strength test at room temperature. In an exemplary embodiment, the silicone material does not substantially adhere to metals. “No substantial adhesion” refers to a peel strength at room temperature of the silicone material to a metal that is not greater than about 10.0 pounds per inch (ppi) when tested in with a standard 180° peel strength test. In an embodiment, the peel strength at room temperature of the silicone material to a metal may not be greater than about 7.5 ppi, or even not greater than about 5.0 ppi. In an embodiment, the silicone material has a peel strength of at least about 10.0 ppi to a fluoropolymer and a peel strength of not greater than about 7.0 ppi to metal. In embodiment, the silicone material has a peel strength of at least about 15.0 ppi to a fluoropolymer and a peel strength of not greater than about 7.0 ppi to metal. In an embodiment, the silicone material has a peel strength of at least about 20.0 ppi to a fluoropolymer and a peel strength of not greater than about 7.0 ppi to metal.

The selective adhesion of the silicone material is particularly useful during a production line. In a conventional production line, the silicone material with the excess hydride-containing siloxane does not substantially adhere to a metal roll. In a particular embodiment, the metal roll is not coated or maintained with any conventional or commercial coating that prevents adhesion of the silicone material to the metal. The selective adhesion to PTFE substrate enables the silicone layer to be removed easily away from the hot roll after vulcanization process. Since a primer is eliminated with the use of the silicone material with the excess hydride-containing siloxane, any conventional steps that a primer adds to the manufacturing process can also be eliminated.

Advantageously, the article may have desirable physical properties. A primer is not used to adhere the silicone material with the fluoropolymer layer such that the article produced has a desirable volatile organic contaminant (VOC) level. For instance, the VOC level of an article that contains an unprimed PTFE layer is substantially undetectable for 4-methyl-2-pentanone as determined by gas chromatography-mass spectrometry (GC MS). Substantially undetectable refers to 4-methyl-2-pentanone measured at a level of less than about 2.0 ppb as determined by GC MS. In contrast, an article that includes primed PTFE has greater than about 10 parts per billion (ppb) for 4-methyl-2-pentanone as measured by GC MS.

Particular embodiments of the above-disclosed multi-layer tube advantageously exhibit desired properties such as chemical stability, flow stability, and increased lifetime. For example, the multi-layer tube may have a pump life of greater than about 200 hours.

### Example 1

Five formulations are prepared for a performance study. Specifically, hydride-containing polydialkylsiloxane (referred to as hydride) is added to a silicone base polymer of vinyl-containing polydialkylsiloxane, silica filler, and a third component platinum catalyst. The mixing process is performed in a two-roll mill. The hydride/silicone base polymer ratio is between 0.4 to 2% by weight of base rubber (phr, part per hundred part of silicone base polymer). The loading of catalyst is 1% phr for all of the formulations. The hydride-containing polydialkylsiloxane is commercially available from Hanse Chemie under the trade name of Cross Linker 100. The platinum catalyst is purchased from Wacker under the trade name of El-Aux-Ptl. The silicone base polymer is Momentive product SE 6035. Formulation data is illustrated in Table 1.

TABLE 1
Example Formulations.

| | % of hydride (phr) |
|---|---|
| Formulation 1 | 0.49 |
| Formulation 2 | 0.58 |
| Formulation 3 | 0.97 |
| Formulation 4 | 1.46 |
| Formulation 5 | 1.95 |

### Example 2

The adhesion properties of the five silicone material formulations against sodium naphthalene etched PTFE and stainless steel are evaluated. Silicone layers having a thickness of about 1 mm to about 2 mm are compression molded onto the two substrates and the molding conditions are about 200° C. for about 3 minutes. The peel test uses an Instron 4465 testing machine. The silicone material layer and the substrates are clamped into the Instron grip. The grip then transverses in the vertical direction at the rate of two inches per minute, which pulls the silicone 180° away from the substrate. The 180° peel test results are summarized in Table 2. The peel test result on a control material commercial HCR is also included in this table for the purpose of comparison.

TABLE 2
Peel strength on selected substrates.

| | sodium | sodium | | |
|---|---|---|---|---|
| | naphthalene | naphthalene | Stainless | |
| | etched PTFE | etched FEP | steel | Aluminum |
| | (ppi) | (ppi) | (ppi) | (ppi) |
| Formulation 1 | 5.1 | 2.4 | 1.5 | 0.9 |
| Formulation 2 | 6.1 | 1.3 | 0.9 | 0.4 |
| Formulation 3 | >20 | 7.4 | 4.4 | 2.7 |
| Formulation 4 | >20 | >20 | 5.0. | 4.7 |
| Formulation 5 | >20 | >20 | 6.2 | 7.5 |
| Control | 2.8 | 1.7 | 0.5 | 1.4 |

Cohesive failure between the silicone material and sodium naphthalene etched PTFE are observed in Formulations 3, 4 and 5. Cohesive failure between the silicone material and sodium naphthalene etched FEP are observed in Formulations 4 and 5. Hence, the adhesion force is greater than the strength of the silicone material. The peel strength is typically greater than 20.0 ppi when cohesive failure occurs.

The bond strength between the silicone material and fluoropolymer layers increases upon the increment of hydride loading in the formulation. High bonding strength is observed when the hydride content is higher than 0.97 phr for the PTFE and 1.46 phr for the FEP. The formulation turns to self-bonding HCR against PTFE substrate and FEP substrate. The bonding between the silicone material and stainless steel remains below 6.2 ppi even upon the maximum loading level in the formulations (1.95 phr). The bonding between the silicone material and aluminum remains below 7.5 ppi even upon the maximum loading level in the formulations (1.95 phr). The bonding of the silicone material to PTFE and FEP is effectively more than three times to that on the stainless steel and almost three times to that on the aluminum. Formulations 3, 4, and 5 show good selective adhesion properties between PTFE and the metals. Formulations 4 and 5 show good selective adhesion properties between FEP and the metals.

When measuring VOC levels, 4-methyl-2-pentanone is detected in the unprimed PTFE used in the examples, whilst over 10 ppb 4-methyl-2-pentanone is measured in the primed PTFE by GC MS.

### Example 3

One formulation is prepared for a performance study. Specifically, hydride-containing polydialkylsiloxane (referred to as hydride) is added to a commercial LSR rubber. The mixing process is performed in a dough mixer during the two part mixing step. The hydride/LSR ratio is about 1.46% by weight of base rubber (phr, part per hundred part of silicone base polymer). The hydride-containing polydialkylsiloxane is commercially available from Hanse Chemie under the trade name of Cross Linker 100. The LSR base polymer is Wacker product LR3003/50.

### Example 4

The adhesion properties of Example 3 against sodium naphthalene etched PTFE and stainless steel are evaluated. Silicone layers having a thickness of about 1 mm to about 2 mm are compression molded onto the two substrates and the molding conditions are about 200° C. for about 3 minutes. The peel test uses an Instron 4465 testing machine. The silicone material layer and the substrates are clamped into the Instron grip. The grip then transverses in the vertical direction at the rate of two inches per minute, which pulls the silicone 180° away from the substrate. The 180° peel test results are summarized in Table 2. The peel test result on a control material base rubber Wacker LR3003/50 is also included in this table for the purpose of comparison.

TABLE 3
Peel strength on selected substrates.

| | sodium naphthalene | Stainless steel |
|---|---|---|
| | etched PTFE (ppi) | (ppi) |
| Example 3 | 13.6 | 1.5 |
| LR3003/50 | 1.7 | 0.2 |

Example 3 has 8 times bond strength to sodium naphthalene etched PTFE, comparing to that of the base rubber.

Similar to Example 1 and 2, a large difference was found in Example 3 between the bond strength of the silicone material to etched PTFE and stainless steel. The bonding of 3 to PTFE is 9 times to that on the stainless steel

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

1. An article comprising:
a first layer comprising a silicone base polymer and a hydride-containing siloxane, wherein the hydride-containing siloxane is present at about 0.1% by weight to about 5.0% by weight of the silicone base polymer; and
a second layer comprising a fluoropolymer,
wherein the first layer has a peel strength of at least about 10.0 ppi to the second layer and a peel strength of not greater than about 7.0 ppi to a metal.

2. (canceled)

3. (canceled)

4. The article of claim 1, wherein the metal is stainless steel, steel, aluminum, titanium, or combination thereof.

5. The article of claim 1, wherein the silicone base polymer is a polyalkylsiloxane.

6. The article of claim 5, wherein the polyalkylsiloxane is platinum-catalyzed.

7. The article of claim 5, wherein the polyalkylsiloxane is a high consistency gum rubber (HCR) or liquid silicone rubber (LSR).

8. The article of claim 1, wherein the hydride-containing siloxane is hydride-containing polydialkylsiloxane.

9. The article of claim 1, wherein the hydride-containing siloxane is present at about 0.4% to about 2.0% by weight of the silicone base polymer.

10. The article of claim 1, wherein the fluoropolymer is polytetrafluoroethylene, fluorinated ethylene propylene copolymer, or a copolymer of tetrafluoroethylene and perfluoropropyl vinyl ether (PFA).

11. (canceled)

12. The article of claim 1, having a volatile organic contaminant (VOC) level that is substantially undetectable for 4-methyl-2-pentanone as measured by gas chromatography-mass spectrometry (GC MS).

13. The article of claim 1, wherein the first layer is disposed directly on the second layer.

14. The article of claim 1, wherein the first layer is substantially free of primer.

15. (canceled)

16. (canceled)

17. (canceled)

18. (canceled)

19. (canceled)

20. (canceled)

21. (canceled)

22. (canceled)

23. (canceled)

24. (canceled)

25. A tube comprising:
a liner comprising a fluoropolymer;
a tie layer overlying the liner, the tie layer comprising a silicone material including a silicone base polymer and a hydride-containing siloxane, wherein the hydride-containing siloxane is present at about 0.1% by weight to about 5.0% by weight of the silicone base polymer;
a reinforced layer overlying the tie layer, the reinforced layer comprising a silicone material including a silicone base polymer and a hydride-containing siloxane, wherein the hydride-containing siloxane is present at about 0.1% by weight to about 5.0% by weight of the silicone base polymer and at least one polyester reinforcement member substantially embedded within the silicone material; and
a cover layer overlying the reinforced layer, the cover layer comprising a silicone material including a silicone base polymer and a hydride-containing siloxane, wherein the hydride-containing siloxane is present at about 0.1% by weight to about 5.0% by weight of the silicone base polymer.

26. The tube of claim 25, wherein the silicone base polymer is a polyalkylsiloxane.

27. (canceled)

28. (canceled)

29. The tube of claim 25, wherein the hydride-containing siloxane is hydride-containing polydialkylsiloxane.

30. The tube of claim 25, wherein the hydride-containing siloxane is present at about 0.4% by weight to about 2.0% by weight of the silicone base polymer.

31. The tube of claim 25, wherein the fluoropolymer is polytetrafluoroethylene, fluorinated ethylene propylene copolymer, or a copolymer of tetrafluoroethylene and perfluoropropyl vinyl ether (PFA).

32. (canceled)

33. The tube of claim 25, wherein the cover is disposed directly on the liner.

34. The tube of claim 25, wherein the cover is substantially free of primer.

35. A method of making an article comprising:
providing a first layer, wherein the first layer comprises a silicone base polymer and a hydride-containing siloxane, wherein the hydride-containing siloxane is present at about 0.4% by weight to about 2.0% by weight of the silicone base polymer;
providing a second layer disposed directly on the first layer to form an article, wherein the second layer comprises a fluoropolymer; and
heating the article.

36. The method of claim 35, wherein the step of heating the article is at a temperature of about 125° C. to about 200° C. for a time of about 1 minute to about 60 minutes.

37. (canceled)

38. The method of claim 35, further comprising the step of surface treating the second layer prior to providing the second layer.

39. (canceled)

40. (canceled)

41. (canceled)

42. (canceled)

43. (canceled)

44. (canceled)

45. The method of claim 35, having a volatile organic contaminant (VOC) level that is substantially undetectable for 4-methyl-2-pentanone by gas chromatography-mass spectrometry (GC MS).

46. The method of claim 35, wherein the silicone base polymer is a polyalkylsiloxane.

47. (canceled)

48. (canceled)

49. The method of claim 35, wherein the hydride-containing siloxane is hydride-containing polydialkylsiloxane.

50. The method of claim 35, wherein the fluoropolymer is polytetrafluoroethylene, fluorinated ethylene propylene copolymer, or a copolymer of tetrafluoroethylene and perfluoropropyl vinyl ether (PFA).
